(19) United States
(12) Patent Application Publication
(10) Pub. No.: US 2025/0324509 A1
(43) Pub. Date: Oct. 16, 2025

(54) DELAY COMPENSATION IN CONDUCTIVE TRACE STRUCTURES

(71) Applicant: Intel Corporation, Santa Clara, CA (US)

(72) Inventors: Chi-Yang Hung, Taipei (TW); Yu-Heng Hsieh, Taipei (TW); Wei-Che Hsu, Taipei (TW); Chang-Ming Lee, Kaohsiung (TW); Kai-Yang Wang, Taipei (TW)

(21) Appl. No.: 19/251,250

(22) Filed: Jun. 26, 2025

(51) Int. Cl. H05K 1/02; G06F 30/3308; H01P 3/08; H05K 1/18

(52) U.S. Cl. CPC H05K 1/0296; G06F 30/3308; H01P 3/081; H05K 1/181

(57) ABSTRACT

An apparatus, including: a simulator configured to estimate signal propagation delays for a plurality of conductive trace structures, wherein the conductive trace structures include at least one tabbed routing structure; a compensator configured to determine trace-specific delay compensation values based on measured actual signal propagation delays obtained from PCB test coupons that include the tabbed routing structure and calculate compensated physical trace lengths using the trace-specific delay compensation values to achieve signal timing alignment; and a correlator configured to correlate estimated signal propagation delays with the measured actual signal propagation delays.

### BACKGROUND

As data rates for devices such as Double Data Rate 5 (DDR5) memory escalate to 8,000 megatransfers per second (MT/s), the demands for signal integrity become increasingly stringent. Ensuring stable operation and compliance with DDR5, upcoming DDR6 interface specifications, and the like requires precise timing control at the printed circuit board (PCB) level. This includes effective signal routing strategies, compensation for delay mismatches, and impedance matching.

In earlier designs, the DDR memory clock (CLK) signal is routed using a microstrip conductive trace structure. For next-generation platforms, the CLK signal will be routed as a stripline conductive trace structure, offering improved isolation, reduced crosstalk, and lower radio frequency interference (RFI) emissions.

However, due to error correction code (ECC) design constraints and limited routing space on the PCB, some command and control (CA and CS) signals will continue to be routed as microstrip conductive traces. This results in a mixed-routing configuration, where the CLK is routed as a stripline conductive trace and the CA and CS signals remain microstrip-based. The differing propagation characteristics between these transmission line types introduce a timing mismatch that requires compensation. This mismatch has historically created challenges for system designers, particularly in implementing tabbed routing layouts. The absence of comprehensive design guidance in this area has led to persistent timing uncertainty and increased layout complexity.

### BRIEF DESCRIPTION OF THE FIGURES

FIG. 1 illustrates a block diagram of a delay compensation system for printed circuit board (PCB) trace signal integrity, in accordance with aspects of the present disclosure.

FIG. 2 depicts a schematic cross-sectional view of a multi-layer PCB routing scheme for signal timing alignment and delay compensation, in accordance with aspects of the present disclosure.

FIG. 3 illustrates a top view of a PCB test coupon designed for tabbed routing delay characterization, in accordance with aspects of the present disclosure.

FIG. 4 illustrates a table summarizing measured propagation delays and corresponding compensation factors for different PCB routing types, in accordance with aspects of the present disclosure.

FIG. 5 illustrates a representative signal net on a PCB that includes both non-tabbed and tabbed microstrip segments, in accordance with aspects of the disclosure.

### DETAILED DESCRIPTION

The present disclosure is directed to signal optimization techniques that resolve delay mismatches, simplify routing implementation, and enhance signal integrity in high-speed memory systems. To achieve these objectives, this methodology emphasizes precise control over signal timing, careful adjustment of trace lengths, proper impedance matching, and reduction of noise and interference during motherboard design.

In high-speed memory systems, such as those utilizing DDR5 and DDR6, precise timing alignment between the clock (CK_t/CK_c) and command/address (CA) signals is important. Without proper synchronization, timing violations can occur, leading to system instability or failure. Traditional design practices often rely on a fixed delay factor to model timing, but this fails to account for real-world variations in PCB trace routing, resulting in inaccurate timing and reduced reliability.

The aspects of the disclosure overcome these limitations by measuring actual delays on the fabricated motherboard and calculating trace-specific compensation values. This process is implemented through a structured four-step methodology: simulation, measurement, compensation, and correlation. Each step improves accuracy and ensures reliable timing for high-speed memory interfaces.

By integrating simulation, real-world measurements, and calibration using PCB test coupons, the aspects of the disclosure enable extraction of trace-specific delay compensation factors. This methodology significantly improves upon conventional fixed-factor approaches, resulting in robust signal integrity, increased design margin, and enhanced system reliability for next-generation memory platforms.

### Delay Compensation System

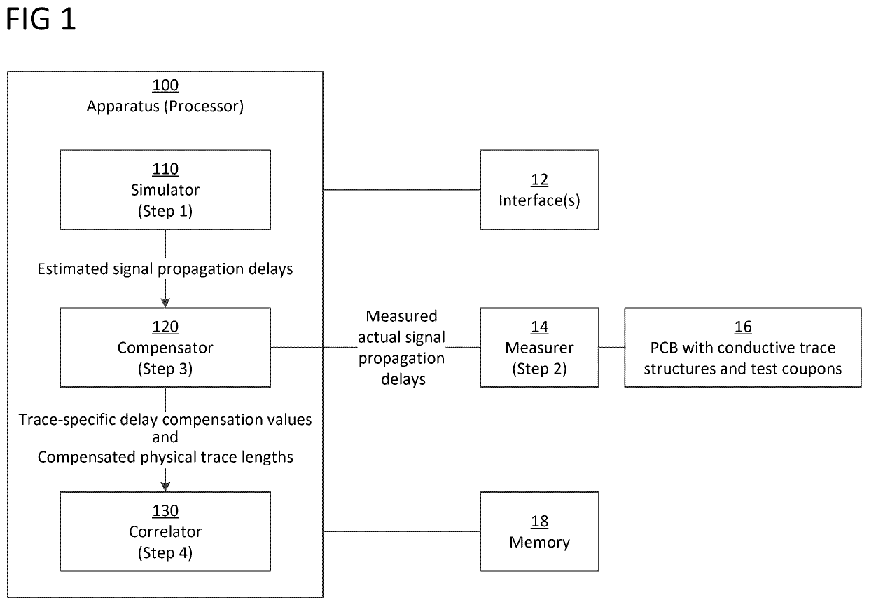

FIG. 1 illustrates a block diagram of a delay compensation system for printed circuit board (PCB) trace signal integrity, in accordance with aspects of the present disclosure.

The system includes an apparatus 100, which may be implemented as one or more processors configured to execute the delay compensation methodology. The apparatus 100 comprises a simulator 110, a compensator 120, and a correlator 130.

The simulator 110 is configured to estimate signal propagation delays for a plurality of conductive trace structures using transmission line models that account for material properties and trace geometry. The simulator 110 may utilize software tools or algorithms to perform these estimations. The conductive trace structures may include at least one tabbed routing structure, which comprises variable geometry based on impedance requirements.

The compensator 120 is configured to determine trace-specific delay compensation values based on measured actual signal propagation delays. These measurements are obtained from PCB test coupons that include tabbed routing structures. The compensator 120 calculates compensated physical trace lengths using the trace-specific delay compensation values to achieve signal timing alignment across different routing types.

The correlator 130 is configured to correlate estimated signal propagation delays generated by the simulator 110 with the measured actual signal propagation delays obtained from the test coupons. This correlation step ensures that the compensation values are accurate and that the simulation models are properly calibrated to real-world conditions.

The apparatus 100 interfaces with one or more external components via interface(s) 12. These interfaces may facilitate communication with measurement equipment, layout tools, or other system components.

A measurer 14, such as a Time Domain Reflectometry (TDR) or Vector Network Analyzer (VNA) instrument, is operatively connected to the apparatus 100. TDR sends a pulse down the trace and measures the time it takes for the pulse to reflect back, providing data on signal timing and impedance. A VNA measures the frequency-dependent behavior of signals, including propagation delay and impedance. The measurer 14 is used to obtain actual signal propagation delay measurements from the PCB 16, which includes the conductive trace structures and dedicated test coupons with tabbed routing. The measurement data is provided to the compensator 120 and the correlator 130 for further processing.

A memory 18 may be operatively coupled to the apparatus 100. The memory 18 may store simulation data, measurement results, compensation values, and other relevant information used by the simulator 110, compensator 120, and/or correlator 130.

Memory 18 may further be configured to store program code or instructions that, when executed by the processor or apparatus 100, cause the system to perform the four-step delay compensation process described herein. These instructions may include operations for simulating signal propagation delays, measuring actual delays using test equipment, calculating and inputting compensation values, and correlating simulation and measurement results. In this manner, memory 18 may comprise a non-transitory computer-readable medium containing instructions that, when executed, enable the apparatus to implement the methodologies and functions disclosed in this specification.

Examples of memory 18 include, but are not limited to, volatile memory such as static random-access memory (SRAM) or dynamic random-access memory (DRAM), and non-volatile memory such as flash memory, electrically erasable programmable read-only memory (EEPROM), or other forms of solid-state storage. Memory 18 may be integrated within the apparatus or provided as an external component, and may comprise a single memory device or a combination of multiple memory devices, as appropriate for the system's requirements.

In operation, the system enables a four-step process: (1) simulation of signal delays using the simulator 110, (2) measurement of actual delays using the measurer 14, (3) calculation and input of compensation values via the compensator 120, and (4) correlation of simulation and measurement results using the correlator 130. This process ensures precise delay compensation and signal timing alignment for high-speed PCB designs, such as those used in DDR5/DDR6 memory interfaces.

### Methodology

This disclosure provides a four-step methodology that integrates simulation, real-world measurements, and calibration to accurately extract and compensate for signal delay on PCB conductive traces. This approach enhances design accuracy for timing-critical buses such as DDR, resulting in improved signal integrity and system reliability.

### Step 1: Simulation (Performed by Simulator 110)

Signal delay and impedance are estimated using standard transmission line models that account for material properties and trace geometry. A simulation tool is employed to model material and structural variations, including the effects of signal integrity and electromagnetic behavior. The simulated delay values are incorporated into the initial PCB layout design to guide early routing decisions and establish a foundation for subsequent physical validation.

### Step 2: Measurement (Performed by Measurer 14)

Time Domain Reflectometry (TDR), Vector Network Analyzer (VNA) instruments, or the like are used to measure the actual propagation delay on the fabricated PCB. These real-world measurements validate and refine the simulation results from Step 1, allowing for fine-tuning to better match actual hardware behavior.

### Step 3: Compensation (Performed by Compensator 120)

The final, corrected delay value (e.g., in ps/inch or ps/mm) is entered into routing constraint tools such as the Automated Trace Length Calculator (ATLC) for layout calibration. ATLC is a software tool integrated into PCB layout software that calculates physical compensation lengths based on the corrected delay values. This trace-specific delay value enables the tool to account for segment-based delay differences and compute accurate physical compensation lengths for each trace segment.

### Step 4: Correlation (Performed by Correlator 130)

Simulation and measurement results are compared using correlation tools such as the Rank Margin Tool (RMT). Tools like the RMT are used to compare and align simulation and measurement data. This step ensures that the delay compensation is properly aligned and accurate, thereby improving design reliability and ensuring stable performance in high-speed systems.

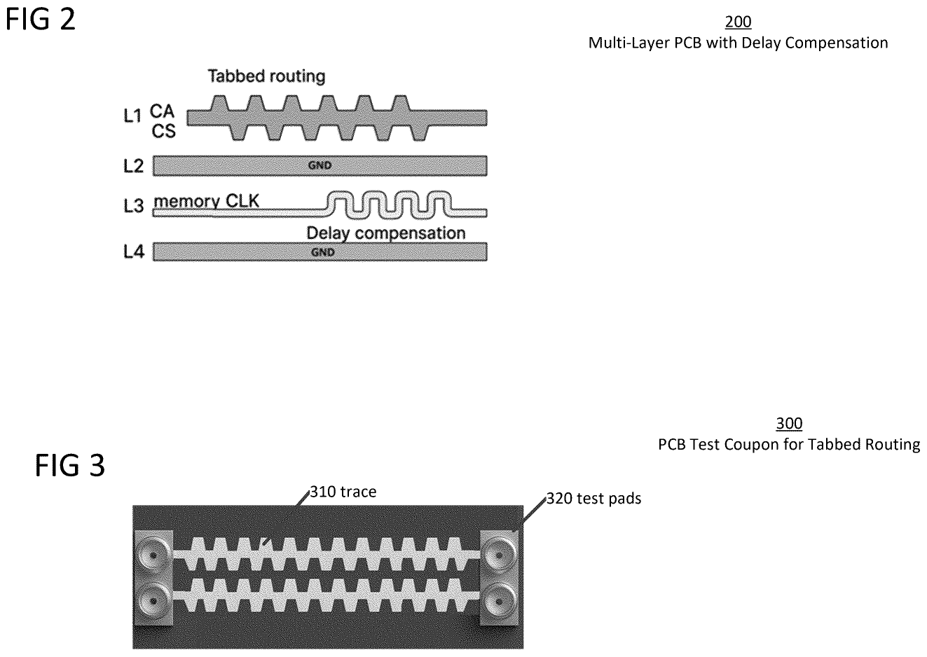

FIG. 2 depicts a schematic cross-sectional view of a multi-layer printed circuit board (PCB) routing scheme 200 for signal timing alignment and delay compensation, in accordance with aspects of the present disclosure.

The figure illustrates four PCB layers: L1, L2, L3, and L4.

Layer L1 is the microstrip conductive trace layer, which carries the command/address (CA/CS) signals. These signals are routed using a tabbed routing structure, shown as a periodic, zig-zag pattern. The tabbed geometry is designed to introduce controlled delay and impedance characteristics to the CA/CS signal paths.

Layer L2 is a ground (GND) reference plane, providing electromagnetic shielding and a stable reference for the signal layers above and below.

Layer L3 is a stripline conductive trace layer dedicated to the memory clock (CLK) signal. The CLK trace is shown with its own delay compensation structure, which may include meanders or other controlled-geometry features to precisely match the timing of the CA/CS signals routed on L1.

Layer L4 is another ground (GND) reference plane, further isolating the signal layers and enhancing signal integrity.

This multi-layer configuration enables precise delay compensation between the stripline routed memory clock signal and the tabbed microstrip tabbed routed CA/CS signals. By carefully designing the tabbed routing on layer L1 and the delay compensation features on layer L3, the system achieves accurate timing alignment across different signal types, supporting high-speed memory interface requirements such as DDR5 and DDR6.

FIG. 3 illustrates a top view of a printed circuit board (PCB) test coupon 300 designed for tabbed routing delay characterization.

Test coupons are small sections of the PCB designed specifically for measuring signal behavior. They may be positioned at the board edges or near unused pins or dummy pad areas and mimic the routing structures (e.g., microstrip, stripline, tabbed microstrip) used in the actual design.

The test coupon includes a conductive trace 310 that follows a periodic, zig-zag, or tabbed pattern along its length. This tabbed routing structure is designed to introduce a controlled delay and specific impedance characteristics, enabling precise extraction of delay values for use in compensation calculations. The trace is flanked by plated through-holes or test pads 320 at each end, which provide electrical access points for measurement instruments such as a TDR and VNA.

By utilizing this test coupon, actual propagation delays associated with the tabbed routing can be directly measured on the fabricated PCB. The resulting data is used to derive trace-specific compensation factors, replacing conventional fixed delay values and enabling accurate timing alignment across mixed routing types in high-speed memory interfaces. This approach supports robust signal integrity and compliance with stringent DDR5/DDR6 timing requirements.

### Experimental Verification

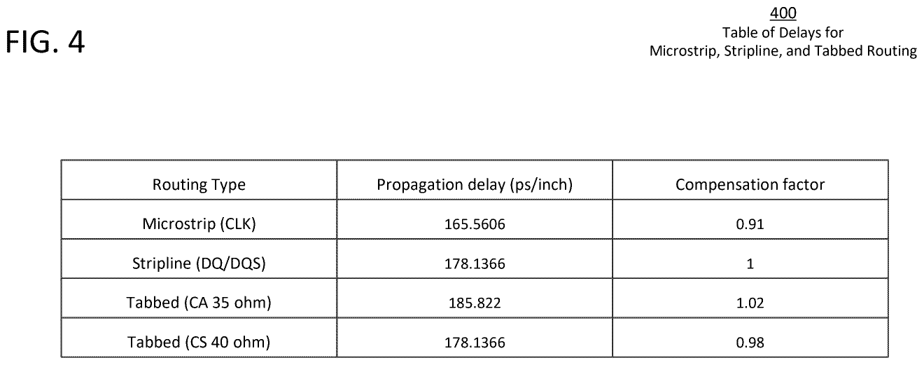

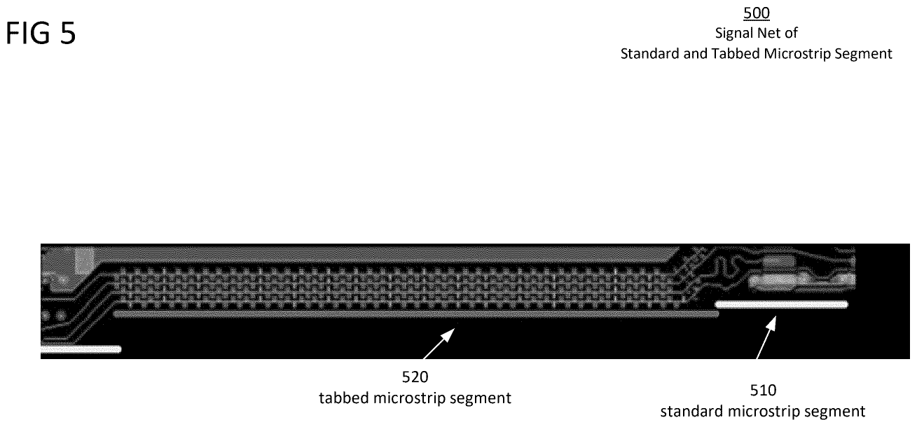

FIG. 4 illustrates a table 400 summarizing measured propagation delays and corresponding compensation factors for different PCB routing types, in accordance with aspects of the disclosure.

The table 400 lists four routing types: microstrip (CLK), stripline (DQ/DQS), tabbed (CA 35 ohm), and tabbed (CS 40 ohm). For each routing type, table 400 provides the measured propagation delay in picoseconds per inch (ps/inch) and the associated compensation factor.

TDR measurements conducted on actual PCBs confirm the accuracy and repeatability of the methodology. The results in FIG. 4 demonstrate distinct propagation delays for each routing structure. Notably, the variations in propagation delay for the tabbed CA and CS signals are attributable to differences in impedance and geometric configuration. This table 400 highlights the benefits of using trace-specific, measurement-driven compensation values, rather than fixed factors, to achieve accurate timing alignment and precise delay matching across mixed routing structures in high-speed memory interfaces.

### Compensation Factor Calculation for Mixed Segments

FIG. 5 illustrates a representative signal net 500 on a PCB that includes both non-tabbed microstrip segments 510 (non-tabbed microstrip segments) and tabbed microstrip segments 520, as used for delay compensation.

In the figure, the length of the tabbed microstrip segment 520 represents a portion of the trace with a periodic, zig-zag, or tabbed geometry. This tabbed structure is designed to introduce additional, controlled signal delay and to adjust impedance as needed for precise timing alignment. The length of the non-tabbed microstrip segment 510 represents a conventional straight trace with typical propagation delay characteristics.

This figure illustrates how a single signal trace can be composed of multiple segments with varying delay properties. The combination of non-tabbed and tabbed segments allows designers to fine-tune the overall signal delay to match the timing requirements of high-speed memory systems, such as DDR5 and DDR6.

The figure supports the methodology described in the disclosure, where the effective average delay across the total trace length is calculated by weighting the propagation delay of each segment by its respective length. This enables accurate calculation of a composite compensation value for the mixed routing segment by determining weighted average delays based on segment lengths and respective propagation delays, ensuring precise timing alignment across mixed routing structures.

For traces composed of mixed segments, such as non-tabbed microstrip segment 510 and tabbed microstrip segment 520, the effective average delay across the total trace length is calculated to ensure accurate timing alignment.

A signal trace may consist of multiple segments, each with distinct delay characteristics. For example, one portion may be a non-tabbed microstrip segment 510, while another portion may be a tabbed microstrip segment 520. To achieve precise delay compensation, the delays contributed by each segment must be combined into a single effective value.

The compensation factor is calculated where:

L_{M}=length of non-tabbed microstrip segment (in inches)(non-tabbed microstrip segment 510)

L_{T}=length of tabbed microstrip segment (in inches)(tabbed microstrip segment 520)

$${D}_{M} = propagation delay of the non - tabbed microstrip segment ( \frac{p s}{i n c h} )$$

$${D}_{T} = propagation delay of the tabbed microstrip segment ( \frac{p s}{i n c h} )$$

$${D}_{S} = propagation delay of the referebce stripline ( \frac{p s}{mil} )$$

The composite average delay is represented by:

$${D}_{a v g} = \frac{( {L}_{M} \times {D}_{M} ) + ( {L}_{T} \times {D}_{T} )}{{L}_{M} + {L}_{T}}$$

The compensation factor to normalize the mixed microstrip and tabbed trace against the stripline reference is:

$$C {F}_{composite} = \frac{{D}_{avg}}{{D}_{s}}$$

### Example Calculation:

Given: L_{M}=0.1 inch, L_{T}=1 inch, Dₘ=165.5606 ps/inch, D_{T}=185.822 ps/inch, D_{S}=178.1366 ps/inch,
calculate the composite delay:

$${D}_{a v g} = \frac{( 0.1 \times 165.5606 ) + ( 1 \times 185.822 )}{0.1 + 1} = 183.071 ,$$

and
calculate the compensation factor:

$$C {F}_{composite} = \frac{{D}_{avg}}{{D}_{s}} = \frac{183.071}{178.1366} = 1.0277 .$$

To align with the delay characteristics of stripline routing, the combined microstrip and tabbed trace should be shortened by a factor of 1.0277, rather than using the conventional 0.9 adjustment. This corrected compensation factor is then entered into layout constraint tools such as the Automated Trace Length Calculator (ATLC), enabling accurate calculation of physical compensation lengths based on the delay contributions of each trace segment. This approach ensures precise timing alignment and robust signal integrity in high-speed PCB designs.

The aspects of the disclosure provide a practical and scalable methodology for achieving precise signal delay compensation in high-speed PCB designs. By integrating simulation, real-world measurements, and calibration using PCB test coupons, the aspects of the disclosure enable extraction of trace-specific delay factors with high accuracy.

Unlike traditional fixed-factor approaches (such as a uniform 0.9 or 1.1 multiplier applied to all microstrip traces regardless of geometry or routing), this data-driven method directly addresses actual differences in routing, whether microstrip, stripline, or tabbed configurations. In legacy designs, reliance on generic compensation factors often led to suboptimal timing alignment and reduced design reliability. In contrast, the aspects of the disclosure utilize direct delay measurement with Time Domain Reflectometry (TDR) or a Vector Network Analyzer (VNA) on dedicated PCB test coupons, which can be positioned at the board edges or near unused pins or dummy pad areas (as illustrated in FIG. 3). These real-world measurements yield trace-specific compensation values, aligning simulation with actual hardware behavior.

As a result, the methodology enhances signal integrity and memory performance, even at elevated DDR5 and DDR6 data rates, resulting in improved system stability and reliability for manufacturers and end-users. By enabling efficient and robust high-speed interfaces, the disclosed technology supports enhanced performance in advanced computing applications, including artificial intelligence, data centers, and other demanding environments. With reliable memory overclocking capabilities, aspects of the disclosure open new opportunities for manufacturers and customers to address the growing demand in high-performance computing, gaming, and professional workstation markets.

The aspects of the disclosure are not limited to DDR or high-speed memory applications. The methodologies and systems described herein may be applied to any electronic system or signal interface where precise timing alignment and delay compensation are required. This includes, but is not limited to, various types of data buses, communication interfaces, and signal routing scenarios in computing, networking, telecommunications, and embedded systems. Accordingly, the principles and techniques disclosed are broadly applicable to a wide range of technologies beyond DDR or high-speed memory, and should not be construed as limited to any particular memory standard or protocol.

Aspects of the disclosure may be implemented in hardware, firmware, software, or any combination thereof. For example, the described functionality may be realized using dedicated hardware circuits, programmable logic devices, application-specific integrated circuits (ASICs), field-programmable gate arrays (FPGAs), microprocessors, or microcontrollers. Alternatively, the processes and methodologies described herein may be embodied in software or firmware instructions stored on a non-transitory computer-readable medium and executed by one or more processors. The choice of implementation may depend on system requirements, performance considerations, and design constraints, and all such variations are within the scope of the present disclosure.

The techniques described in this disclosure may also be illustrated in the following examples.

Example 1. An apparatus, comprising: a simulator configured to estimate signal propagation delays for a plurality of conductive trace structures, wherein the conductive trace structures include at least one tabbed routing structure; a compensator configured to determine trace-specific delay compensation values based on measured actual signal propagation delays obtained from printed circuit board (PCB) test coupons that include the tabbed routing structure and calculate compensated physical trace lengths using the trace-specific delay compensation values to achieve signal timing alignment; and a correlator configured to correlate estimated signal propagation delays with the measured actual signal propagation delays.

Example 2. The apparatus of example 1, wherein the tabbed routing structure comprises variable geometry based on impedance requirements.

Example 3. The apparatus of any one or more of examples 1-2, wherein the conductive trace structures comprise mixed routing segments including non-tabbed microstrip segments and tabbed microstrip segments.

Example 4. The apparatus of example 3, wherein the compensator is further configured to calculate composite delay values for the mixed routing segments by determining weighted average delays based on segment lengths and respective propagation delays.

Example 5. The apparatus of any one or more of examples 1-4, wherein the trace-specific delay compensation values replace fixed delay compensation factors.

Example 6. The apparatus of any one or more of examples 1-5, wherein the conductive trace structures comprise stripline trace structures and microstrip trace structures.

Example 7. The apparatus of example 6, wherein the stripline trace structures route clock signals and the microstrip trace structures route command and control signals.

Example 8. The apparatus of any one or more of examples 1-7, wherein the simulator is configured to estimate the signal propagation delays using transmission line models that account for material properties and trace geometry.

Example 9. The apparatus of any one or more of examples 1-8, wherein the compensator is further configured to input the trace-specific delay compensation values into layout constraint tools to calculate the compensated physical trace lengths.

Example 10. The apparatus of any one or more of examples 1-9, wherein the PCB test coupons are positioned at board edges or near unused pin areas.

Example 11. A system, comprising: a plurality of conductive trace structures including at least one tabbed routing structure; one or more printed circuit board (PCB) test coupons formed on the PCB including the tabbed routing structure; and a processor operatively coupled to the PCB and configured to: estimate signal propagation delays for the conductive trace structures; determine trace-specific delay compensation values based on measured actual signal propagation delays obtained from the PCB test coupons; calculate compensated physical trace lengths using the trace-specific delay compensation values to achieve signal timing alignment; and correlate estimated signal propagation delays with the measured actual signal propagation delays.

Example 12. The system of example 11, wherein the tabbed routing structure comprises variable geometry based on impedance requirements.

Example 13. The system of any one or more of examples 11-12, wherein the conductive trace structures comprise mixed routing segments including non-tabbed microstrip segments and tabbed microstrip segments.

Example 14. The system of example 13, wherein the processor is further configured to calculate composite delay values for the mixed routing segments by determining weighted average delays based on segment lengths and respective propagation delays.

Example 15. The system of any one or more of examples 11-14, wherein the trace-specific delay compensation values replace fixed delay compensation factors.

Example 16. The system of any one or more of examples 11-15, wherein the conductive trace structures comprise stripline trace structures and microstrip trace structures.

Example 17. The system of example 16, wherein the stripline trace structures route clock signals and the microstrip trace structures route command and control signals.

Example 18. The system of any one or more of examples 11-17, wherein the processor is configured to estimate the signal propagation delays using transmission line models that account for material properties and trace geometry.

Example 19. The system of any one or more of examples 11-18, wherein the processor is further configured to input the trace-specific delay compensation values into layout constraint tools to calculate the compensated physical trace lengths.

Example 20. The system of any one or more of examples 11-19, wherein the PCB test coupons are positioned at board edges or near unused pin areas.

Although specific aspects have been illustrated and described herein, it will be appreciated by those of ordinary skill in the art that a variety of alternate and/or equivalent implementations may be substituted for the specific aspects shown and described without departing from the scope of the present application. This disclosure is intended to cover any adaptations or variations of the specific aspects discussed herein.

1. An apparatus, comprising:
a simulator configured to estimate signal propagation delays for a plurality of conductive trace structures, wherein the conductive trace structures include at least one tabbed routing structure;
a compensator configured to determine trace-specific delay compensation values based on measured actual signal propagation delays obtained from printed circuit board (PCB) test coupons that include the tabbed routing structure and calculate compensated physical trace lengths using the trace-specific delay compensation values to achieve signal timing alignment; and
a correlator configured to correlate estimated signal propagation delays with the measured actual signal propagation delays.

2. The apparatus of claim 1, wherein the tabbed routing structure comprises variable geometry based on impedance requirements.

3. The apparatus of claim 1, wherein the conductive trace structures comprise mixed routing segments including non-tabbed microstrip segments and tabbed microstrip segments.

4. The apparatus of claim 3, wherein the compensator is further configured to calculate composite delay values for the mixed routing segments by determining weighted average delays based on segment lengths and respective propagation delays.

5. The apparatus of claim 1, wherein the trace-specific delay compensation values replace fixed delay compensation factors.

6. The apparatus of claim 1, wherein the conductive trace structures comprise stripline trace structures and microstrip trace structures.

7. The apparatus of claim 6, wherein the stripline trace structures route clock signals and the microstrip trace structures route command and control signals.

8. The apparatus of claim 1, wherein the simulator is configured to estimate the signal propagation delays using transmission line models that account for material properties and trace geometry.

9. The apparatus of claim 1, wherein the compensator is further configured to input the trace-specific delay compensation values into layout constraint tools to calculate the compensated physical trace lengths.

10. The apparatus of claim 1, wherein the PCB test coupons are positioned at board edges or near unused pin areas.

11. A system, comprising:
a plurality of conductive trace structures including at least one tabbed routing structure;
one or more printed circuit board (PCB) test coupons formed on the PCB including the tabbed routing structure; and
a processor operatively coupled to the PCB and configured to:
estimate signal propagation delays for the conductive trace structures;
determine trace-specific delay compensation values based on measured actual signal propagation delays obtained from the PCB test coupons;
calculate compensated physical trace lengths using the trace-specific delay compensation values to achieve signal timing alignment; and
correlate estimated signal propagation delays with the measured actual signal propagation delays.

12. The system of claim 11, wherein the tabbed routing structure comprises variable geometry based on impedance requirements.

13. The system of claim 11, wherein the conductive trace structures comprise mixed routing segments including non-tabbed microstrip segments and tabbed microstrip segments.

14. The system of claim 13, wherein the processor is further configured to calculate composite delay values for the mixed routing segments by determining weighted average delays based on segment lengths and respective propagation delays.

15. The system of claim 11, wherein the trace-specific delay compensation values replace fixed delay compensation factors.

16. The system of claim 11, wherein the conductive trace structures comprise stripline trace structures and microstrip trace structures.

17. The system of claim 16, wherein the stripline trace structures route clock signals and the microstrip trace structures route command and control signals.

18. The system of claim 11, wherein the processor is configured to estimate the signal propagation delays using transmission line models that account for material properties and trace geometry.

19. The system of claim 11, wherein the processor is further configured to input the trace-specific delay compensation values into layout constraint tools to calculate the compensated physical trace lengths.

20. The system of claim 11, wherein the PCB test coupons are positioned at board edges or near unused pin areas.
